(19) United States
(12) Patent Application Publication
(10) Pub. No.: US 2006/0163775 A1
(43) Pub. Date: Jul. 27, 2006

(54) Method and device for producing a cover for an airbag in a motor vehicle

(75) Inventors: Philipp Kroell, Taufkirchen/Vils (DE); Thomas Klisch, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/388,023

(22) Filed: Mar. 24, 2006

Related U.S. Application Data
(63) Continuation of application No. PCT/EP04/10310, filed on Sep. 15, 2004.

(30) Foreign Application Priority Data
Sep. 26, 2003 (DE) 103 44 708.3

(51) Int. Cl. B29C 45/00; B29C 59/00

(52) U.S. Cl. 264/293; 264/328.1; 425/317

(57) ABSTRACT

A method and device for producing a cover for an airbag in a motor vehicle are provided, wherein a carrier component made of plastic material is formed by injection molding. The carrier component is provided with weakening grooves which delimit flaps permitting the deployment of the airbag. The carrier component is also provided with a top material on its exterior side facing away from the airbag. After injection molding the carrier component, in the still plastically deformable state, the grooves are formed in the carrier component by hot stamping.

### CROSS-REFERENCE TO RELATED APPLICATIONS

This application is a continuation of PCT Application No. PCT/EP2004/010310 filed on Sep. 15, 2004, which claims priority to German Application No. 103 44 708.3 filed Sep. 26, 2003, the disclosures of which are incorporated by reference herein.

### BACKGROUND AND SUMMARY OF THE INVENTION

The invention relates to a method for producing a cover for an airbag in a motor vehicle, whereby a carrier component made of plastic material is formed by injection molding. The carrier component is provided with weakening or rupture grooves which delimit the flaps permitting the exit of the airbag. The carrier component is also provided with a top material on an exterior side facing away from the airbag. The invention also relates to a device for implementing such a method.

In the case of a method of the above-mentioned type described in European Patent document EP 0 586 222 A2, the carrier component is provided with weakening grooves during injection molding. An injection molding device is used for implementing this known method, which has two mold halves that may be moved relative to one another and, in a closed condition, delimit a cavity corresponding the shape of the carrier component. In this case, the mold half delimiting the interior side of the carrier component is equipped with ribs having a V-shaped cross-section, which correspond to the course of the grooves. This mold half has several openings for injecting the heated and liquified plastic material. When the plastic material is injected, the top material forms a durable connection with the carrier component. As a result of the projecting ribs, the thickness of the carrier component is reduced locally in order to obtain a weakening line or predetermined breaking point. However, as a result of this local reduction of the mold cavity, the spreading of the injected liquid plastic material is hindered. This has the result that the injected liquid plastic material does not spread over the rib in the mold cavity, but rather that the flows of plastic injected through different openings meet one another in the area of the reduced cross-section. This flowing front leads to an inhomogeneous bonding of the plastic material flows of an undefined strength. The strength of the carrier plate in the area of the grooves is, therefore, subject to fluctuations, so that the break-open behavior of the carrier plate is not uniform when the air bag is triggered. However, this is unacceptable for reasons of safety.

It is an aspect of the invention to improve the above-mentioned method such that the strength of the carrier component in the area of the grooves, and thus the break-open behavior, may be defined, and is uniform.

According to one aspect of the invention, after the injection molding, the carrier component is provided with grooves by hot stamping in the still plastically deformable condition. Since the liquid plastic material injected into the mold cavity can spread unhindered, a homogeneous matrix for the carrier component is obtained. As a result of the fact that the grooves are produced by hot stamping this matrix, a defined and uniform breaking strength of the carrier component is ensured in the area of the grooves.

In the case of the method known from European Patent document EP 0 586 222 A2 discussed above, the grooves are constructed on the interior side of the carrier component facing the airbag. The groove is, therefore, not shown at the top surface of the material, that is, its course cannot be seen from the exterior side. However, the forming of the grooves on the interior side of the carrier component is disadvantageous from a strength-related point of view. When the airbag is triggered, the carrier component is first deformed, that is, arched toward the outside, in which case the V-shaped grooves close increasingly. In the area of the weakening lines of the carrier component defined by the grooves, there arises therefore no notch effect favoring the breaking-open. Rather, such a notch effect will arise when a force is exercised upon the carrier component from the direction of the exterior side. If the carrier component is a door covering, this may take place during the closing of the door when the door covering impacts on the occupant's body part, for example, the knee. In such a case, there is therefore the danger that the carrier component will break because of the notch effect occurring in the area of the grooves.

According to another embodiment of the method according to the invention, it is therefore provided that the grooves are formed on the exterior side of the carrier component, that a foam plate covering the grooves is applied to this side of the carrier component, and that the top material is applied to the foam plate. By means of these measures, it is, on the one hand, achieved that the notch effect promoting the breaking-open of the carrier component will occur when a force is exercised upon the interior side of the carrier component when the airbag is triggered. On the other hand, it is ensured that the grooves do not show through the top material and their course cannot be seen from the direction of the exterior side. From a production-related point of view, it is advantageous for the foam plate and the top material to be connected by pressure laminating with the carrier component or with one another by use of an adhesive which may be thermally activated.

As known from European Patent document EP 0 586 222 A2 discussed above, an injection molding machine is disclosed having two mold halves, which may be moved relative to one another and which, in the closed condition, delimit a cavity corresponding to the shape of the carrier component. According to the present invention, a stamping die forming the grooves is advantageously integrated into a mold half delimiting the exterior side of the carrier component, to which stamping die an application device is assigned. After the injection of the liquid plastic material, the stamping die is moved into the still liquid matrix and the grooves are formed, which are decisive for the required weakening contour. The application device advantageously comprises a wedge drive, which permits an extremely precise application stroke of the stamping die. The formation of the weakening contour in the plastically deformable matrix of the carrier component may, therefore, take place with high precision and repeatability.

Other objects, advantages and novel features of the present invention will become apparent from the following detailed description of the invention when considered in conjunction with the accompanying drawings.

### BRIEF DESCRIPTION OF THE DRAWINGS

FIG. 1 is a cutout-type top view of a carrier component of a covering for an airbag;

FIG. 2 is a cross-sectional view of a finished covering corresponding to Line II-II in FIG. 1; and

FIG. 3 is a schematic representation of a device for producing the covering according to the invention.

### DETAILED DESCRIPTION OF THE DRAWINGS

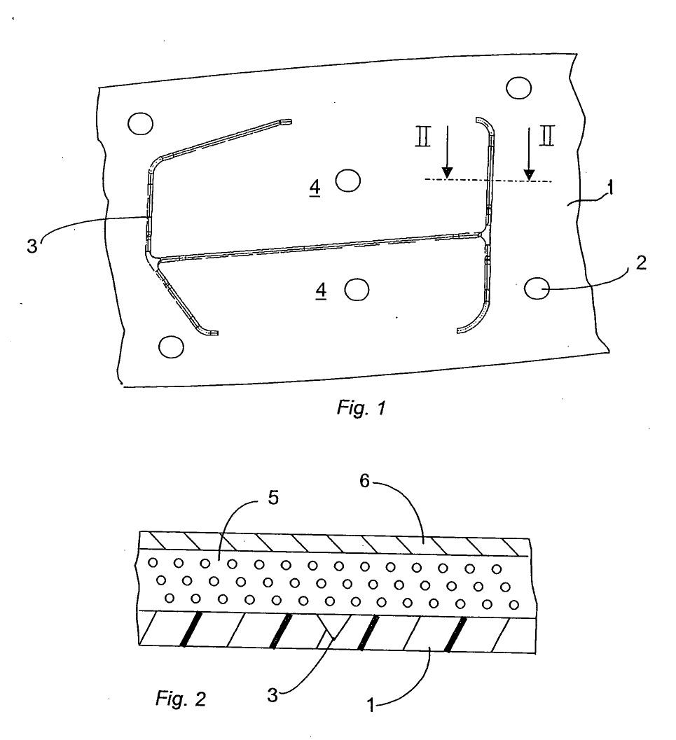

FIG. 1 is a top view of an exterior side of a carrier component 1 which faces away from an airbag when in a motor vehicle. The carrier component 1 is produced of plastic material by injection molding, and several injection marks 2 are visible. As explained in greater detail in the following, in the course of its production, the carrier component 1 is provided with grooves 3 on its exterior side, which grooves 3 have a V-shaped cross-section. In the area of the grooves 3, the cross-section of the carrier component 1 is weakened, so that rupture lines are created. The grooves 3 delimit two areas 4, which two areas form the flaps 4 permitting the exit or deployment of the airbag (not shown). After breaking-open the carrier component 1 in the area of the grooves 3, the two flaps may be swivelled outward. For facilitating this swivellability, the carrier component 1 may be provided with a groove on the interior side in the area between the grooves 3.

As illustrated in FIG. 2, a foam plate or layer 5 is arranged on the exterior side of the carrier component 1 provided with the grooves 3, and a top material 6, such as leather, is arranged on the exterior side of the foam plate 5. The foam plate 5 prevents the grooves 3 from showing through at the top material 6. The foam plate 5 and the top material 6 may be connected with the carrier component 1 or with one another by pressure laminating. For this purpose, the foam plate 5 may be coated on both sides with an adhesive which may be thermally activated. These adhesive layers may be successively heated and activated, so that, by way of hot pressing, the foam plate 5 may first be connected with the carrier component 1, and subsequently with the top material 6.

When, during triggering of the airbag, a force is exercised upon the interior side of the carrier component 1 (from the bottom in FIG. 2), the latter is first arched toward the outside (upward in FIG. 2). A notch effect thus occurs in the area weakened by the grooves 3. As soon as the force exercised by the airbag exceeds a predetermined value, the carrier component 1 will tear along the rupture lines defined by the grooves 3, and the two flaps 4 open toward the outside, so that the airbag can deploy into the interior compartment of a motor vehicle in order to protect the occupants from an impact. It is recognizable that the illustrated covering is equally suitable for an airbag arranged in various areas, including without limitation the steering wheel, the instrument panel, and/or a door.

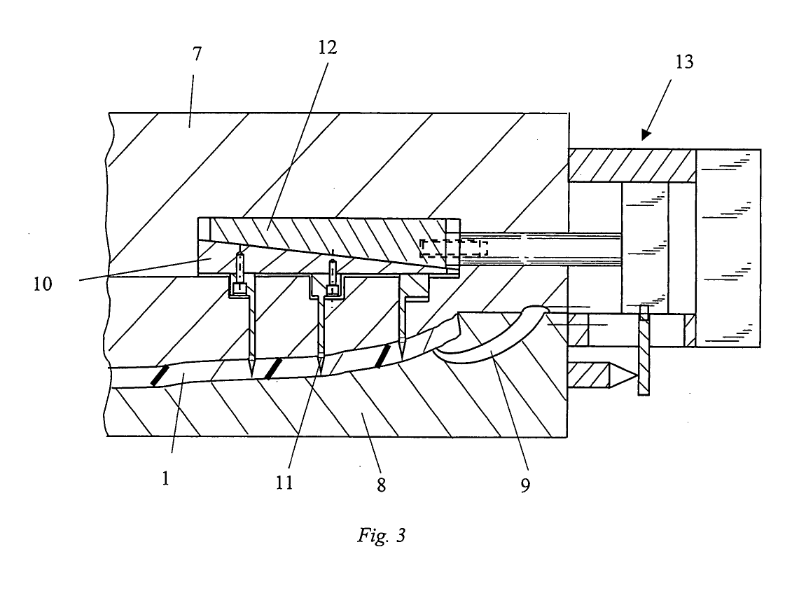

FIG. 3 is a schematic view of a device for producing the carrier component 1. This device comprises an injection molding machine having an upper mold half 7 and a lower mold half 8. The lower mold half 8 is arranged at a variable distance with respect to the upper mold half 7, and a driving device (not shown) is assigned to it. Several injection ducts 9 are formed in the lower mold half 8, only one of which is shown in FIG. 3. The two mold halves 7 and 8 delimit a cavity corresponding to the shape of the carrier component 1. A stamping die 10 is integrated in the upper mold half 7. On its underside, this stamping die 10 is equipped with ribs 11 corresponding to the shape and the course of the grooves 3. The stamping die 10 is disposed in the upper mold half 7 and is displaceable at a right angle with respect to the top side of the carrier component 1 and is equipped with a driving device 13.

In the illustrated embodiment of FIG. 3, the top side of the stamping die 10 has a diagnosed construction with respect to its displacement direction. This diagonally formed top side rests against a corresponding diagonal surface of a driving component 12, which can be displaced at a right angle with respect to the application direction of the stamping die 10. For this purpose, a driving device 13 is assigned to the driving component 12, which driving device 13 permits a precisely definable transverse movement of the driving component 12. Such a so-called “wedge drive” permits an application movement of the stamping die 10, which can be repeated with high precision.

During production of the carrier component 1, the stamping die 10 is first arranged at such a height that its ribs 11 do not project into the cavity delimited by the two mold halves 7 and 8. The plastic material injected into the cavity is, therefore, not hindered by the ribs 11 of the stamping die 10, so that it can spread in a free and unhindered manner within the cavity. The matrix formed in the cavity by the liquid plastic material therefore has a homogeneous structure. As a result of a corresponding displacement of the driving component 12 to the left (as shown in FIG. 3), the stamping die 10 is moved downward by a defined extent. In this case, the ribs 11 constructed at the underside of the stamping die 10 penetrate into the still liquid matrix of the carrier component 1 and produce the grooves 3 that form the weakening or rupture lines. After the carrier component 1 has cooled and hardened, the two mold halves 7 and 8 may be separated from one another and the carrier component 1 can be removed. Because of the homogeneous structure, the breaking strength of the carrier component 1 in the area of the grooves 3 can be precisely defined and reproduced.

The carrier component 1 is then connected with the foam plate 5 and the top material 6 in the above-described manner in order to form the desired covering.

A person skilled in the art will recognize that, instead of the foam plate 5, other suitable materials may also be used to ensure that the grooves 3 do not show at the top material 6. In addition to the pressure laminating process, other methods may also be used for durably connecting the individual components with one another for forming the finished covering.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for producing a cover for an airbag in a motor vehicle, the method comprising the acts of:
injection molding plastic material to form a carrier component of the cover;
following the injection molding act, hot stamping grooves into the carrier component while the carrier component is still in a plastically deformable state, the hot stamped grooves forming rupture lines which delimit flaps in the cover that permit deployment of an airbag; and
arranging a top material on one side of the carrier component, which one side is configured as an exterior side facing away from the airbag when installed in the motor vehicle.

2. The method according to claim 1, wherein the grooves are formed on the exterior side of the carrier component, the method further comprising the act of applying a foam plate to cover the grooves on the exterior side of the carrier component, the top material being applied to the foam plate.

3. The method according to claim 2, further comprising the act of pressure laminating via a thermally activated adhesive the foam plate and the top material with the carrier component or with another.

4. A device for performing the method according to claim 1, the device comprising an injection molding machine having two mold halves movable relative to one another, wherein in a closed condition, the two mold halves delimit a cavity corresponding to a desired shape of the carrier component; and
further wherein a stamping die, which provides the hot stamping of the grooves, is integrated in one of the two mold halves that delimits the exterior side of the carrier component, an application device being operatively assigned to the stamping die.

5. The device according to claim 4, wherein the application device is a wedge drive.
